(19) United States
(12) Patent Application Publication
(10) Pub. No.: US 2022/0129505 A1
(43) Pub. Date: Apr. 28, 2022

(54) OBJECT STORAGE DATA STORAGE APPROACHES

(71) Applicant: Seagate Technology LLC, Fremont, CA (US)

(72) Inventors: Deepak Nayak, Pune (IN); Hemant Mohan, Pune (IN)

(21) Appl. No.: 17/081,036

(22) Filed: Oct. 27, 2020

(51) Int. Cl. G06F 16/901; G06F 12/02; G06F 12/109

(52) U.S. Cl. CPC G06F 16/9027; G06F 2212/7201; G06F 12/109; G06F 12/0246

(57) ABSTRACT

A method includes receiving, by a processor, a data retrieval command from a host requesting data. In response to the data retrieval command, the method includes searching a mapping for the requested data. The mapping includes a tree structure with a series of nodes and a linked list associated with each node. The method further includes identifying portions of the linked list associated with the requested data and communicating the requested data to the host.

### SUMMARY

In certain embodiments, a method includes receiving, by a processor, a data retrieval command from a host requesting data. In response to the data retrieval command, the method includes searching a mapping for the requested data. The mapping includes a tree structure with a series of nodes and a linked list associated with each node. The method further includes identifying portions of the linked list associated with the requested data and communicating the requested data to the host.

In certain embodiments, an enclosure includes sub-enclosures positioned at different levels along the enclosure, data storage devices positioned within the sub-enclosures, and a central processing integrated circuit. The circuit is programmed to store and retrieve data on the data storage devices according to a first mapping stored on memory communicatively coupled to the central processing integrated circuit. The first mapping includes a first tree structure with a first series of nodes and a first linked list associated with each node.

In certain embodiments, a system includes an enclosure with sub-enclosures positioned at different levels along the enclosure and data storage devices positioned within the sub-enclosures. The data storage devices include a group of hard disk drives and a group of magnetic tape drives. The system further includes memory that stores a first set of virtual addresses associated with data stored to the group of hard disk drives and a second set of virtual addresses associated with data stored to the group of magnetic tape drives.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 shows a data storage system, in accordance with certain embodiments of the present disclosure.

FIG. 2 shows a schematic perspective view of a sub-enclosure of the data storage system of FIG. 1, in accordance with certain embodiments of the present disclosure.

FIGS. 3 and 4 show schematics of the data storage system's software architecture, in accordance with certain embodiments of the present disclosure.

FIGS. 5-8 show various data structures used by the data storage system, in accordance with certain embodiments of the present disclosure.

FIG. 9 depicts a diagram of a virtual address approach, in accordance with certain embodiments of the present disclosure.

FIGS. 10 and 11 depict diagrams of mappings used to organize data, in accordance with certain embodiments of the present disclosure.

FIG. 12 shows a block diagram of steps of a method, in accordance with certain embodiments of the present disclosure.

While the disclosure is amenable to various modifications and alternative forms, specific embodiments have been shown by way of example in the drawings and are described in detail below. The intention, however, is not to limit the disclosure to the particular embodiments described but instead is intended to cover all modifications, equivalents, and alternatives falling within the scope of the appended claims.

### DETAILED DESCRIPTION

The demand for cloud data storage services continues to grow, resulting in vast amounts of data being stored to data storage systems in private clouds and public clouds. To help accommodate this increased demand, data storage systems continue to increase the amount of data that can be stored in a given size of enclosure. However, this increased storage capacity can make it challenging to quickly store data and retrieve stored data. Certain embodiments of the present disclosure are accordingly directed to approaches for data storage systems to organize data for storage and retrieval.

### Data Storage System and Enclosure

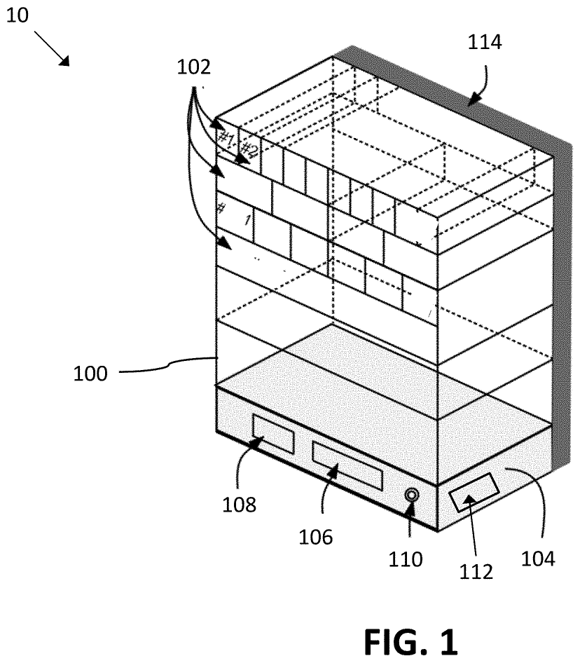

FIG. 1 shows a schematic of a data storage system 10 with an enclosure 100 or cabinet that houses various sub-enclosures 102. The enclosure 100 also includes a controller sub-enclosure 104 that houses components such as power supplies 106, control circuitry 108, memory 110, and one or more interfaces 112 for transferring data signals and communications signals to and from the data storage system 10. For example, the data storage system 10 may be communicatively coupled to a host, which sends data and control commands to the data storage system 10. The host can be a physically separate data storage system.

The data storage system 10 can include a back-plane printed circuit board 114 that extends along the back of the enclosure 100. The back-plane printed circuit board 114 communicates data signals, command signals, and power to and from each of the sub-enclosures 102 and the controller sub-enclosure 104.

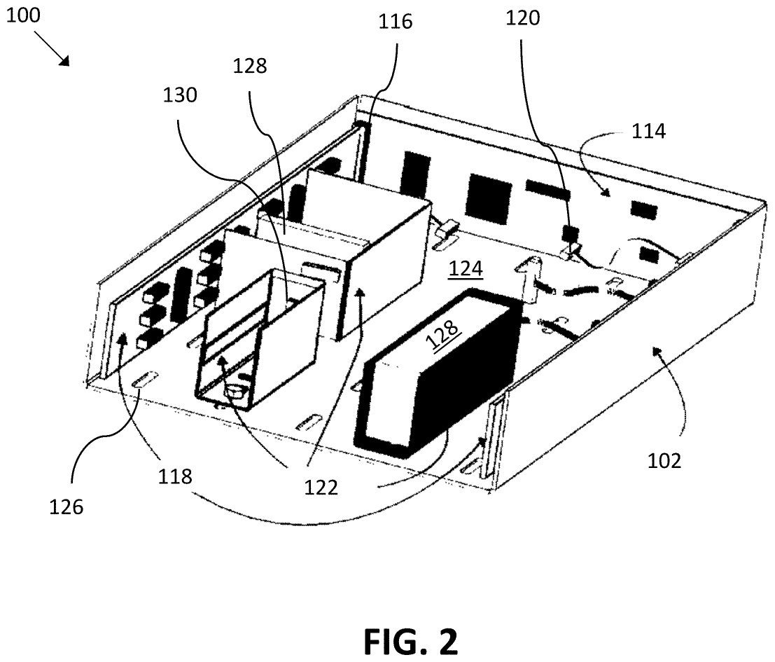

FIG. 2 shows a schematic of one of the sub-enclosures 102 within the enclosure 100. In certain embodiments, the sub-enclosure 102 can include a drawer-like structure that can be slid into and out of the enclosure 100 such that an operator can access the sub-enclosure 102 and its components. In other embodiments, the sub-enclosure 102 is stationary although individual components can be moved into and out of the sub-enclosure 102.

FIG. 2 shows the sub-enclosure 102 with a portion of the back-plane printed circuit board 114 extending at the back of the sub-enclosure 102. The back-plane printed circuit board 114 includes or is coupled to electrical connectors 116 that are electrically and mechanically coupled between the back-plane printed circuit board 114 and side-plane circuit boards 118. As shown in FIG. 2, the side-plane printed circuit boards 118 extend along the sides of the sub-enclosure 102 and include or are coupled to various electrical connectors 120. The data signals, control signals, and power signals from the back-plane printed circuit board 114 can be distributed among the side-plane printed circuit boards 118 and eventually to data storage devices positioned within the sub-enclosure 102.

The sub-enclosure 102 includes cages 122, and the cages 122 are coupled to a floor 124 of the sub-enclosure 102. As shown in FIG. 2, the floor 124 includes openings or slots 126 at different points along the floor 124. The slots 126 allow the configuration of the sub-enclosure 102 to be customized or modular. The cages 122 can also include slots or holes with similar spacing to the slots 126 such that fasteners can extend through the slots/holes of the cages 122 and the slots 126 in the floor 124 and couple or secure the cages 122 to the floor 124.

The cages 122 are sized to house one or more data storage devices 128. For example, one cage may house one or more hard disk drives, another cage may house a magnetic tape drive, and another cage may house a solid-state drive. In certain embodiments, one or more of the cages 122 can house multiple of the same type of data storage device. For example, one or more of the cages 122 may essentially form what is sometimes referred to as “Just a Bunch Of Drives” (JBODs). Other example data storage devices 128 include optical data storage devices such as optical discs (e.g., CDs, DVDs, LDs, BluRays, archival discs). The cages 122 allow the sub-enclosures 102 to be modular such that the sub-enclosures 102 can include different types of data storage devices.

Each cage 122 can include an interface 130 (e.g., electrical connector) that is sized to connect with the designed type of data storage device 128. For example, for cages 122 that are intended to function with hard disk drives, the cages 122 can include interfaces 130 that work with hard disk drive protocols such as SATA and SAS interfaces, among others. The interfaces 130 can be electrically and communicatively coupled to the electrical connectors 120 coupled to the side-plane printed circuit boards 118. Other example interface protocols include PCIe, SCSI, NVMe, CXL, Gen-Z, etc.

Because the enclosure 100 and individual sub-enclosures 102 can include multiple types of data storage devices 128 that utilize different protocols for transferring data, power, and commands, the enclosure 100 and individual sub-enclosures 102 may include various adapters and/or converters. These adapters and/or converters can translate or convert data, control, and power signals between or among different data storage protocols. In addition to the adapters and/or converters, the enclosure 100 can include other electronic and communication devices such as switches, expanders, and the like.

### Data Storage Architecture

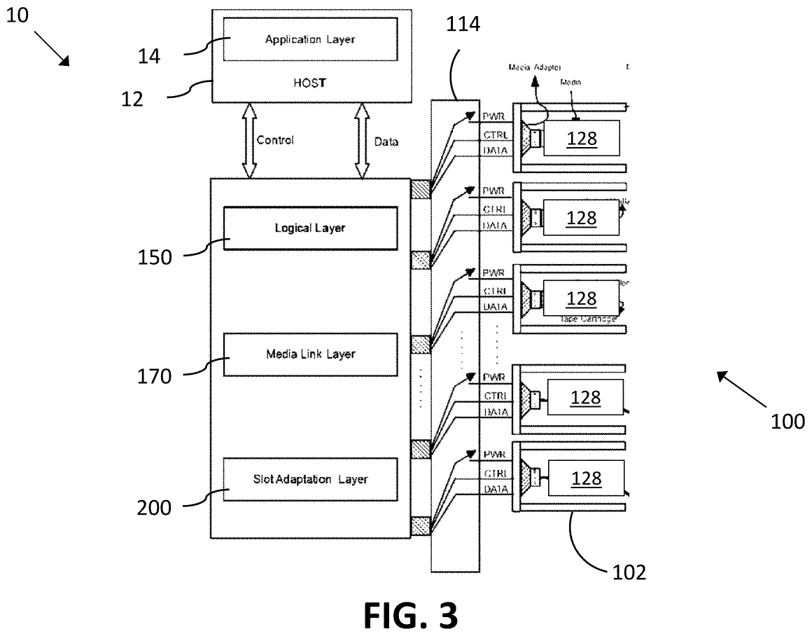

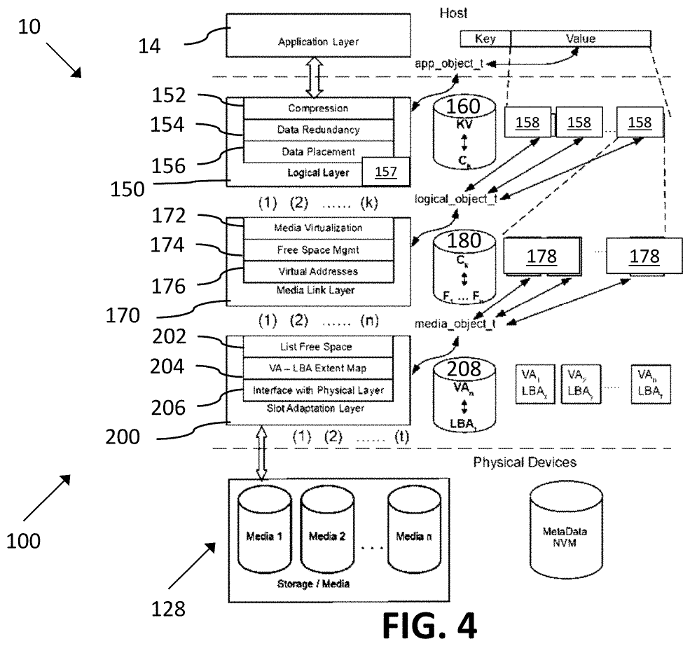

FIGS. 3 and 4 show schematics of the data storage system's data storage or software architecture. In certain embodiments, the data storage system 10 is an object-storage data storage system that is programmed to receive and send data structure using object-storage protocols. Object storage protocols utilize what are referred to as key-value pairs to store, organize, and retrieve data—as opposed to file-folder-like directories—which will be described in more detail below. Although the description below focuses on object-storage approaches, the features of the enclosure 100 can utilize other data storage approaches.

The data storage system 10 includes a host 12, which is communicatively coupled to the enclosure 100 but physically separate from the enclosure 100. The host 12 includes and operates an application layer 14. The host 12 can include its own data storage devices, memory, processors, interfaces, and the like to operate the application layer 14. The application layer 14 is programmed to interact with the enclosure 100 in terms of key-value pairs.

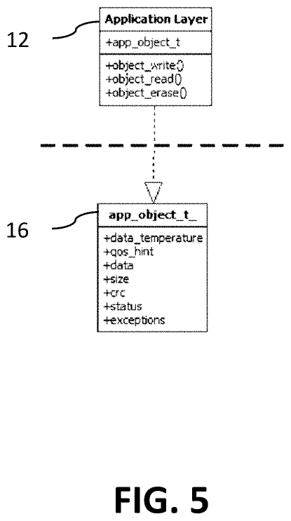

FIG. 5 shows a schematic of an example of a data structure 16 that can be packaged in a key-value pair 18 and sent to the enclosure 100. The data structure 16 is referred to as “app_object_t” in FIG. 5. The data structure 16 can include information (e.g., metadata) that indicates parameters or characteristics of the data to be sent. The information in the data structure 16 can include the data temperature, quality of service (QoS) hint, size or amount of data, status, and exceptions related to the data. This data structure 16 along with the data itself can be sent to the enclosure 100. In addition to the data structure 16, the host 10 via the application layer 12 can send control commands such as read, write, and erase commands.

Referring back to FIGS. 3 and 4, the enclosure 100 includes multiple software layers that are used for organizing and processing data sent and requested by the host 10. Each layer can include its own memory (e.g., RAM) for cache and longer-term data storage. For example, each layer can include memory dedicated for quickly processing “in-flight” data as it is received by the layer and other memory dedicated to storing one or more databases associated with the layer.

These layers can be stored and operated by the control circuitry 108 and memory 110 of the controller sub-enclosure 104 portion of the enclosure 100. As will be described in more detail below, the data received by the enclosure 100 is passed through each layer before ultimately being stored on one or more of the data storage devices 128 in the enclosure 100.

### Logical Layer

Referring to FIG. 4, the layer of the enclosure 100 that interacts directly with the host 10 is referred to as a logical layer 150. The logical layer 150 includes logic or programming for data compression and decompression 152, data redundancy 154, data placement 156, and data encryption 157. The logical layer 150 can use various techniques to compress data sent to the enclosure 100 for storage and decompress data retrieved from the enclosure 100. The data encryption 157 logic can encrypt incoming data that is in-flight as well as at-rest. In certain embodiments, the data encryption 157 logic decrypt data retrieved by one of the data storage devices 128.

The logical layer 150 can also apply techniques to create multiple copies of the incoming data such as RAID and erasure coding techniques. For write operations, the logical layer 150 can create a replica of the incoming data, perform a parity check, and send the replicated data to distinct data storage devices 128. For read operations, the logical layer 150 can reconstitute the original data and confirm fidelity of the reconstituted data with the parity check.

The logical layer 150 also determines which type of data storage device 128 that the incoming data will be sent. In certain embodiments, the logical layer 150 does not, however, determine which specific data storage device 128 will receive or retrieve the data. The determination of which type of storage media to use can be based, at least in part, on information from the data structure 16 received by the logical layer 150. As noted above, the data structure 16 includes information such as data temperature (e.g., data indicating frequency of access) and quality of service hints. The determination of which storage media type to store the incoming data can also be based on which types of data storage devices 128 have enough capacity (e.g., free space) given the size of the incoming data.

In certain embodiments, the logical layer 150 attempts to store incoming data to the type of data storage device that is best suited for the incoming data. For example, incoming data associated with a “low” temperature (e.g., infrequently accessed data) can be stored to lower-cost, higher-capacity data storage devices 128 such as devices with optical media or magnetic tape media, as opposed to solid-state drives or hard disk drives storage media types. In some embodiments, after initially assigning data to a particular media type, the logical layer 150 can identify data that has not been accessed for a predetermined amount of time or that has been frequently accessed and reassigns that data to a more appropriate storage media type.

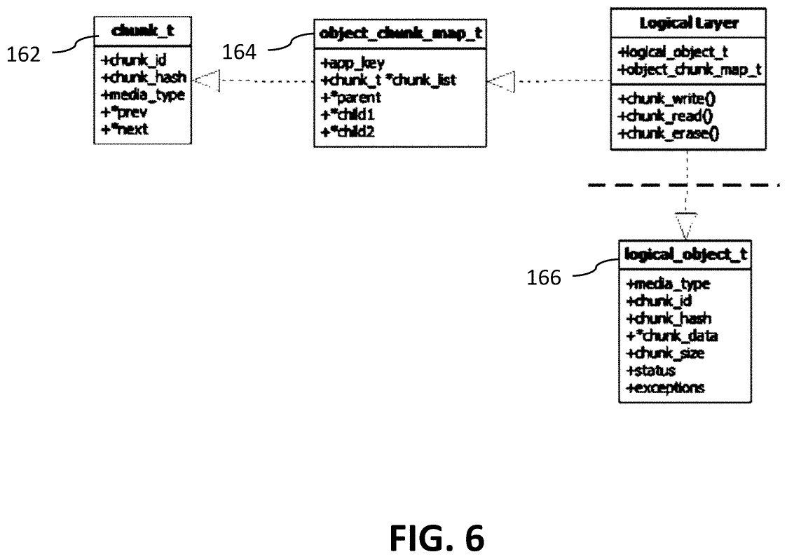

The logical layer 150 is configured to split the incoming key-value pair data into multiple separate sets of data 158 before the sets of data 158 are sent to the next layer within the stack. To distinguish these sets of data 158 with other described with respect to the other layers, the sets of data 158 will be referred to as “chunks 158” and are represented by “logical_object_t” in FIG. 6.

Each chunk 158 is given a unique chunk_id number by the logical layer 150. The chunk_id numbers monotonically increase as more chunks 158 are created. The chunk_id numbers are stored in a database 160 associated with the logical layer 150. The database 160 also stores a mapping between the chunk_id and the key value associated with the chunk_id. In certain embodiments, chunks 158 created from the same key-value pair can be stored to different data storage devices 128 and even different types of storage media.

FIG. 6 shows various data structures created and used by the logical layer 150. A database data structure 162 includes high-level information about each chunk_id. For example, the database data structure 162 can include information such as the chunk_id number itself, a hash, and media type associated with that chunk_id number. The mapping data structure 164 includes information about which key value is associated with a given chunk_id. The database data structure 162 and the mapping data structure 164 are stored in the database 160.

The chunk package data structure 166 (referred to as “logical_object_t” in FIG. 6) includes additional information (e.g., metadata) about the data ultimately to be stored to one or more of the data storage devices 128. This information can include the size or amount of data, status, and exceptions related to the data. The data structure 166 along with the data itself can be sent to the next layer in the stack.

### Media Link Layer

Referring back to FIG. 4, the next layer is referred to as a media link layer 170. The media link layer 170 includes logic or programming for media virtualization 172, free space management 174, and virtual addressing 176.

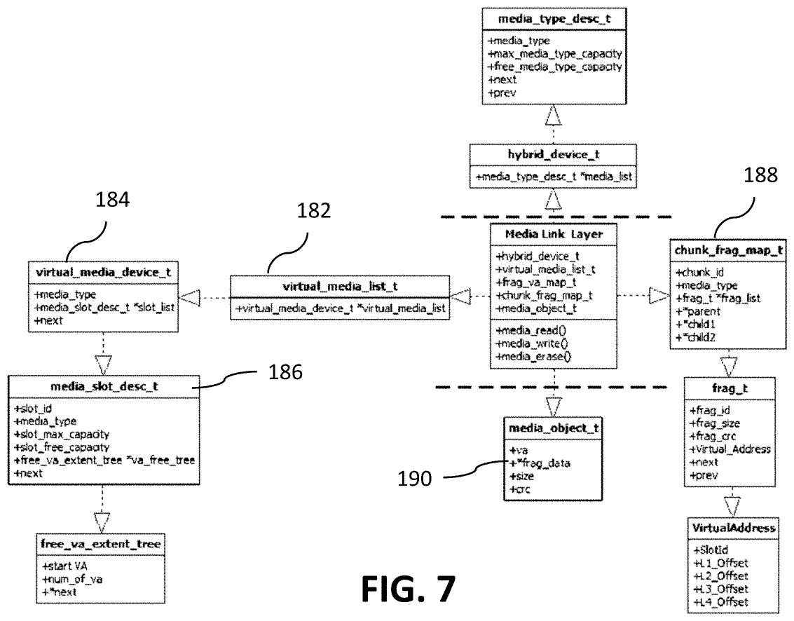

The media virtualization 172 logic functions to virtualize or group together data storage devices 128 having the same media type. For example, the media virtualization 172 logic may create an abstraction layer that groups all of the hard disk drives of the enclosure 100 such that the hard disk drives appear as a single data storage device to the logical layer 150 and media link layer. The media virtualization 172 logic can do the same for all solid-state-media-based data storage devices, optical-media-based data storage devices, and magnetic-tape-media-based data storage devices. As such, when the logical layer 150 determines what type of media one of the chunks 158 should be stored, the logical layer 150 does not necessarily need to determine which specific data storage device 128 will be storing the data. As will be described in more detail below, each different virtual storage media is represented by an instance of “hybrid_device_t” in FIG. 7, and the different types of media are represented by “media_type_desc_t” in FIG. 7.

The free space management 174 logic determines and coordinates how much free space is available on the virtual storage media. For example, when the enclosure 100 is initially started or sometimes periodically during operation, the media link layer 170 can query the slot layer (described further below) and request information about how much storage capacity is available for each of the types of storage media. The available capacities of each type of storage media can be compiled and represented as the total available capacity for each virtual storage media. As such, the media link layer 170 can provide information to the logical layer 150 about which types of media are available for storage and how much capacity is available for each type of storage media. This information can be provided without the logical layer 150 or media link layer 170 needing to keep track of individual data storage devices 128 and their available capacity.

Working in conjunction with the media virtualization 172 logic and the free space management 174 logic, the virtual addressing 176 logic organizes the virtual media and where data is stored on the virtual media. In certain embodiments, before being given a virtual address and sent to the next layer in the stack, the chunks 158 of data are further split into smaller sets of data. To distinguish these sets of data 178 with others sets described with respect to the other layers, the sets of data 178 will be referred to as “fragments 178” and are represented by “media_object_t” in FIG. 7. In certain embodiments, each fragment 178 has a size that is equivalent to the size of a block and/or sector format of one or more of the data storage devices 128. For example, the data storage device 128 may have block and/or sector sizes of 512 bytes or 4000 bytes, and so the fragments 178 would likewise have a size of 512 bytes or 4000 bytes.

Each fragment 178 is given a unique virtual address by the media link layer 170. The virtual addresses are stored in a database 180 associated with the media link layer 170. The database 180 also stores a mapping between the assigned virtual addresses and respective chunk_ids.

FIG. 7 shows various data structures created and used by the media link layer 170, some of which have already been introduced and described above. The media link layer 170 utilizes a list 182 of the created virtual storage media. A data structure 184 is created for each virtual storage media and includes information (e.g., type of storage media) about that media. Another data structure 186 stores information received by the slot adaption layer about individual data storage devices 128 (sometimes referred to as “slots”) and their available capacity. As mentioned above, a mapping of the fragments' virtual addresses and the chunk_ids is stored, and that mapping can be stored according to another data structure 188.

A fragment package data structure 190 (referred to as “media_object_t” in FIG. 7) includes additional information (e.g., metadata) about the data ultimately to be stored to one or more of the data storage devices 128. This information can include the assigned virtual address and size or amount of data. The data structure 190 along with the data itself can be sent to the next layer in the stack.

### Slot Layer

Referring back to FIG. 4, the next layer is referred to as a slot layer 200. The slot layer 200 can also be referred to as the data storage device layer. The slot layer 200 includes logic or programming for free space calculations 202, virtual address to physical mapping 204, and hardware interfacing 206. As noted above, each data storage device 128 may be referred to as a slot. In short, the slot layer 200 abstracts individual data storage devices for the upper layers and maps virtual addresses to physical addresses on the individual data storage devices.

The free space calculations 202 logic queries the data storage devices 128 to collect and list how much available capacity is available for each data storage device 128. Each data storage device 128 in the list can be associated with a storage media type. As part of querying the data storage devices 128 for available capacity, other information can be collected such as each device's status, properties, health, etc. In certain embodiments, each data storage device 128 stores product information, which is information about the individual device itself. The product information can include information regarding the type of media, storage protocol, and unique product identification number.

The virtual address to physical mapping 204 (hereinafter “VA-LBA mapping 204” for brevity) receives the virtual address assigned to each of the fragments 178 by the media link layer 170 and determines which data storage device 128 the fragment 178 should be stored. Further, the VA-LBA mapping 204 determines and assigns physical addresses for the virtual addresses. For example, if the virtual address given to a fragment 178 is associated with the virtualized hard disk drives, the slot layer 200 will assign the fragment 178 to a logical block address (LBA) in one of the hard disk drives in the enclosure 100. For optical data storage devices, the slot layer 200 will assign the fragment 178 to a sector on an optical disk.

The hardware interfacing 206 logic interfaces with the individual data storage devices 128. For example, the hardware interfacing 206 logic can include or have access to device drivers and/or hardware abstraction layers that enable the slot layer 200 to communicate with the different types of data storage devices 128 and among different protocols.

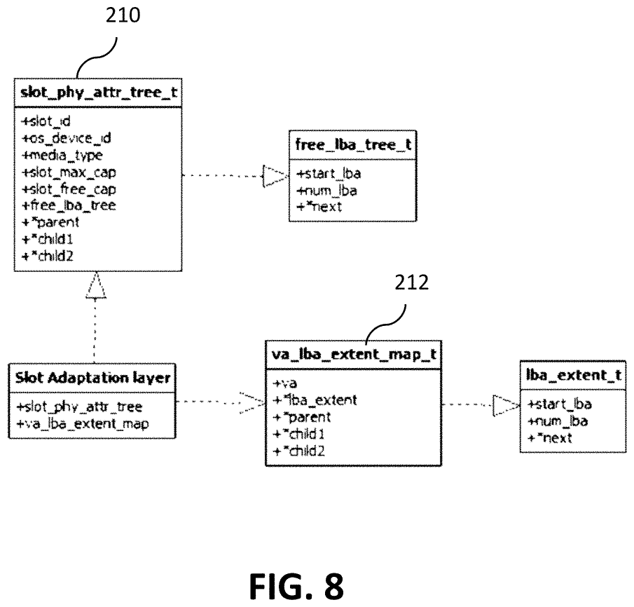

FIG. 8 shows various data structures created and used by the slot layer 200. The data structures can be stored to a database 208 (shown in FIG. 4) associated with the slot layer 200. The slot layer 200 includes a data structure 210 for each data storage device 128 that includes information about the given data storage device 128. The information can include a unique slot_id number for the data storage device 128 and information about the data storage device's operating system, type of storage media, maximum capacity, available capacity, and available physical addresses, among other things. This data structure 210 can be sent to the media link layer 170.

As mentioned above, a mapping of the fragments' virtual addresses and the physical addresses is stored, and that mapping can be stored according to another data structure 212. Once a fragment 178 is assigned a physical address on a data storage device 128, the fragment 178 can be stored to that physical address.

### Virtual Addresses

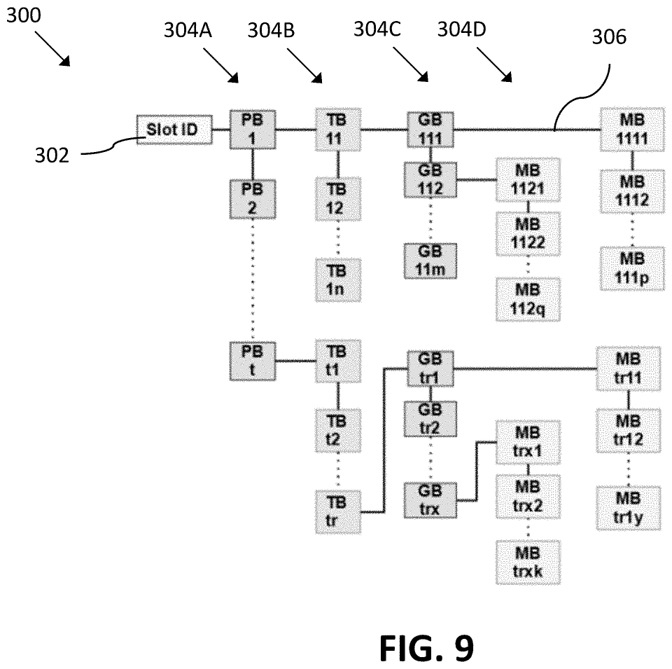

FIG. 9 shows a diagram 300 of a virtual address approach that can be used by the enclosure 100, although it is appreciated that other approaches can be used by the enclosure 100. Each type of storage media can be associated with its own diagram 300. For example, each type of storage media may utilize a separate set of virtual addresses to keep track of the location data within a given type of storage media. One set of virtual addresses can be associated with all hard disk drives in the enclosure 100 while another set of virtual addresses can be associated with all magnetic tape drives in the enclosure 100, and so on. The virtual addresses can be stored in memory within the enclosure 100. As shown in FIG. 9, the diagram 300 has a tree-like structure with various branches connected to each other.

As noted above, each fragment 178 is assigned a unique virtual address. In certain embodiments, each virtual address is a unique string of digits that indicates the starting location of each fragment 178 within the virtual address space. For example, the virtual addresses can be a 64-bit string of digits where various ranges of bit numbers are dedicated to different portions of the virtual addresses. As will be described in more detail below, these different portions of the virtual addresses can indicate which one of the data storage devices 128 the fragments 178 are assigned to and storage “offsets” indicating the location within the selected data storage device 128.

As shown in FIG. 9, the diagram 300 includes a slot number 302 or slot ID. Each data storage device 128 is assigned a unique slot number 302, so the slot number 302 indicates which specific data storage device 128 a given virtual address is associated with.

The diagram 300 also includes different storage offsets 304A-D or levels. In the example of FIG. 9, each of the storage offsets 304A-D represents a different storage capacity. For example, the first storage offset 304A represents a petabyte (PB) offset, the second storage offset 304B represents a terabyte (TB), the third storage offset 304C represents a gigabyte (GB), and the fourth storage offset 304D represents a megabyte (MB). The last storage offset—the fourth storage offset 304D in FIG. 9—can represent the size of the individual fragments 178.

All storage offsets 304B-D associated with the first petabyte can include a “1” as the initial digit, all storage offsets 304C and 304D associated with the first terabyte can include “11” as the first two digits, and the fourth storage offset 304D associated with the first gigabyte can include “111” as the first three digits. The diagram 300 shows each of the respective storage offsets 304A-D being connected by branches 306, which represent the hierarchical relationship between the storage offsets 304A-D.

Using the above-described approach, each virtual address can be expressed as an ordered combination of the slot number 302 and storage offsets 304A-D. The virtual addresses can be assigned and accessed quickly. Put another way, the tree-like virtual address approach can provide fast, hierarchical access to virtual addresses within the virtual address space. Further, the virtual address approach allows multiple individual data storage devices with different types of storage media to be abstracted and viewed as a composite storage media.

### Data Organization Approaches

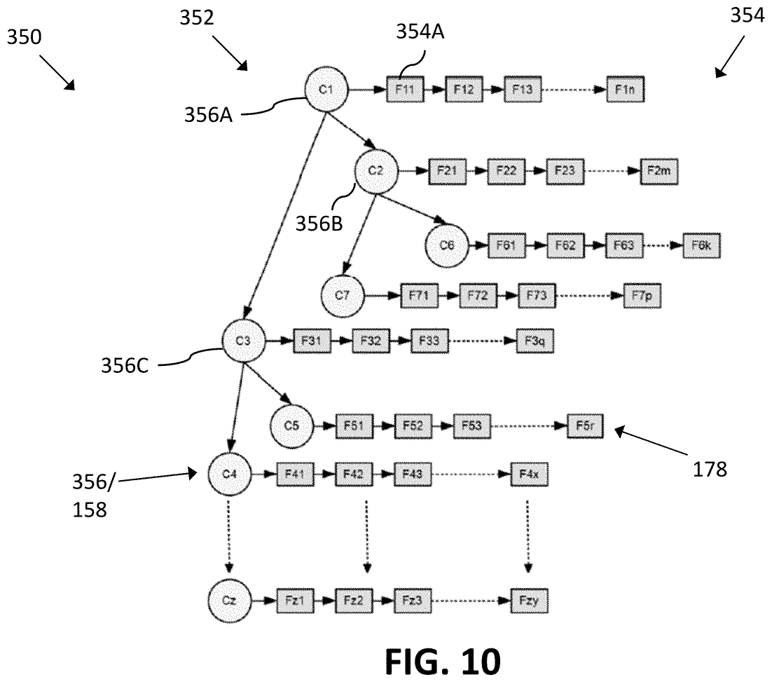

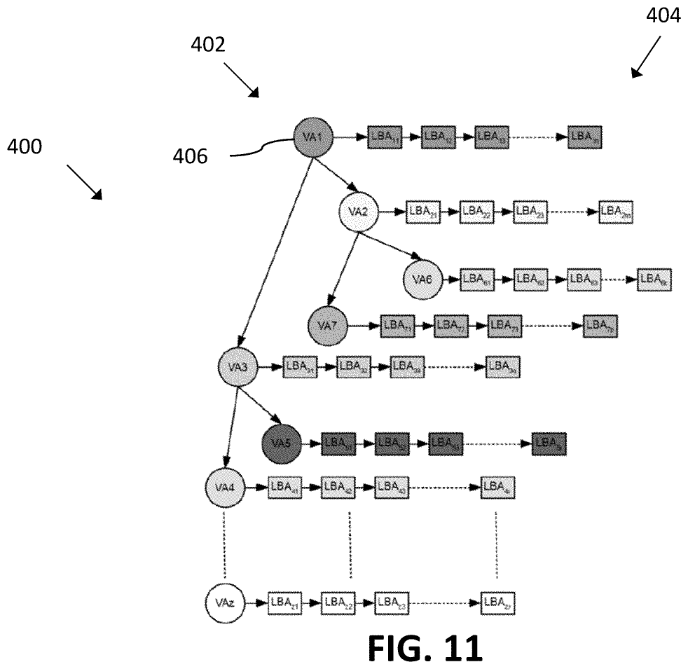

FIGS. 10 and 11 show diagrams 350 and 400 of approaches for creating and maintaining the mapping of the various data structures described above. FIG. 10 represents an example of chunk-to-fragment mapping, and FIG. 11 represents an example of virtual-address-to-LBA mapping. In certain embodiments, the diagrams 350 and 400 can be considered to be data structures. These data structures dictate how different pieces of data stored in the enclosure 100 are organized and associated (or not associated) with each other. As will be described in more detail below, these approaches help with being able to quickly store and retrieve data stored in the enclosure 100.

The diagram 350 of FIG. 10 includes a tree structure 352 and linked lists 354. As such, the diagram 350 may be referred to as a tree-list-combination data structure. The tree structure 352 includes nodes 356 (e.g., a root or leaves) that are logically connected to each other. In particular, the nodes 356 could be arranged with respect to each other to form what is sometimes referred to as a M-way search tree, balanced B tree, or a balanced B+ tree, etc. In the example of FIG. 10, each node 356 represents a chunk 158 (as also shown in FIG. 4) created by the logical layer 150 with the first chunk (labeled “C1” in FIG. 10) being represented by the root node 356A. Two nodes 356B and 356C are logically connected to the root node 356A, and two additional nodes are logically connected to each of the two nodes 356B and 356C and so on until each chunk 158 is represented by one of the nodes 356.

As noted above, unlike the fragments 178, the chunks 158 can have different sizes. For example, one chunk 158 may include data that occupies 2 gigabytes while another one of the chunks 158 may include data that occupies 3 terabytes. As such, the chunks 158 may have a different number of fragments 178 associated with each other.

To map the associated fragments 178 to the chunks 158, the diagram 350 can include one linked list 354 for each node 356 of the tree structure 352. Put another way, each node 356 can be attached to one linked list 354. Each linked list 354 can include nodes where each node contains a data field and a reference (e.g., link) to the next node in the list. To distinguish between the nodes 356 of the tree structure 352, the nodes of the linked list 354 may be referred to as linked-list nodes.

Each fragment 178 in the linked lists 354 is assigned a unique alphanumeric string of characters. In certain embodiments, the first digit of the unique string of characters indicates the number of the associated chunk 158. The following digits can indicate the ordering of the particular fragment 178 in the linked list 354. For example, as shown in FIG. 10, the first fragment in the linked list 354A associated with the first node 356A is represented by “F11,” and the next fragments in the linked list 354A is numbered consecutively as “F12” followed by “F13” and so on until each fragment in the linked list 354A is assigned a unique string of characters. The same process can be carried out for other linked lists 354 within the diagram 350.

As data is fully ingested by the enclosure 100, the central processing integrated circuit can split the incoming data from chunks 158 into fragments 178. Using the mapping of the diagram 350, the chunks 158 can be organized into nodes 356 in the tree structure 352. As the chunks 158 are split into fragments 178, each fragment 178 can be organized into a linked list 354 that is associated with one node 356. If data is deleted or transferred to a different type of storage media, the mappings stored in the enclosure 100 can be updated to reflect the current location of data within the enclosure 100.

The diagram 350 or mapping of the nodes 356 and linked lists 354 can be used when data needs to be retrieved. This approach for mapping the stored data can help retrieve data faster and more efficiently than other approaches. As one example, if the data was organized by a single list of sequential file numbers, the list would need to be scanned and compared against the requested file number until that file number was successfully located. However, using the mapping shown in FIG. 10, the requested chunk 158 can be quickly identified first (via scanning the list of nodes 356) and then the associated linked list 354 can be scanned for the requested fragment 178 or ranges of fragments 178. As another example, the tree-list combination utilizes advantages of both the tree structure and linked-list structure. Using the tree structure, multi-level indexes are compressed which increases performance by making the indexes loadable into faster main memory such as RAM. Further, when querying the mapping, the tree structure 352 can be read first and the linked lists 354 can be read on demand which reduces RAM usage.

In addition to using the tree-list-combination approach for chunk-to-fragment mapping, a similar approach can be used for virtual-address-to-LBA mapping, as shown in FIG. 11. FIG. 11 shows the diagram 400 with a tree structure 402 and linked lists 404. The tree structure 402 includes nodes 406 that are logically connected to each other. In particular, the nodes 406 can be arranged with respect to each other to form what is sometimes referred to as a balanced M-way search tree, balanced B tree, or balanced B+ tree, etc. In the example of FIG. 11, each node 406 represents a virtual address.

To map the associated physical addresses (e.g., logical block addresses or LBAs) to the virtual addresses, the diagram 400 can include one linked list 404 for each node 406 of the tree structure 402. Using the mapping of the diagram 400, the virtual addresses can be organized into nodes 406 and each physical address can be organized into a linked list 404 that is associated with one node 406.

Although the mappings described above focused on the chunk-to-fragment mapping and the virtual-address-to-LBA mapping, similar approaches can be used by the logical layer 150 to map the incoming key-value pair data into the chunks 158. For example, nodes can be used to represent the key and linked lists can be used to represent the chunks 158 or values associated with the key. As such, the tree-list-combination approach can be applied to different mappings within the enclosure 100.

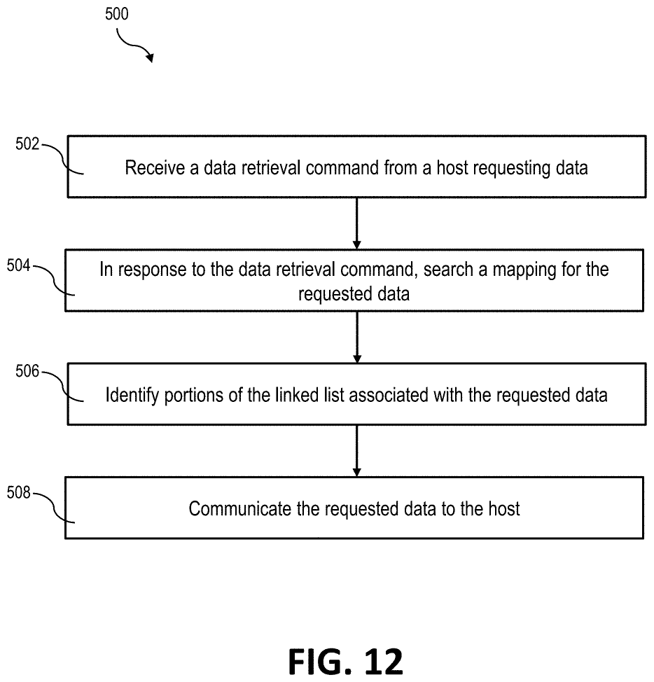

Given the above, components of the enclosure 100 can carry out various approaches for storing and retrieving data. FIG. 12 outlines one example of such a method 500. The method 500 includes receiving, by a processor (e.g., central processing integrated circuit), a data retrieval command from a host requesting data (block 502 in FIG. 12). The method 500 further includes—in response to the data retrieval command—searching a mapping for the requested data (block 504 in FIG. 12). As noted above, the mapping can include a tree structure comprising a series of nodes and a linked list associated with each node. Next, the method 500 includes identifying portions of the linked list associated with the requested data (block 506 in FIG. 12). For example, the portions may be chunks 158, fragments 178, or physical addresses represented by linked-list nodes. The requested data is then sent to the host (block 508 in FIG. 12).

### CONCLUSION

By combining the various features and approaches described above in the enclosure 100, the enclosure 100 can provide an object storage data storage system that can utilize a variety of types of data storage devices. These data storage devices can include “fast” storage media such as SSDs, NVDIMMs, and persistent memory, “traditional” high-capacity storage media such as HDDs and optical disks; and relatively cheaper but slower storage media such as magnetic tape. In certain embodiments, the enclosure 100 incorporates sub-systems such as JBODs, JBOFs, PODS, RBODs, etc. The enclosure 100 can essentially replicate the functions of what previously would require multiple distinct enclosures. As such, the enclosure 100 can reduce the cost of data storage by obviating the need for multiple enclosures, each with their own software, processors, and hardware such as the chassis or physical enclosure itself.

The primary functions of the enclosure 100 can be managed by a central processing integrated circuit. The central processing integrated circuit can manage the amount of power directed to the various electrical components of the enclosure 100 and how data is communicated to and from the data storage devices 128, as described above. For example, the central processing integrated circuit can operate and manage the different layers and their functions described above.

In certain embodiments, the central processing integrated circuit comprises a field-programmable gate array (FPGA), application-specific integrated circuit (ASIC), application processor, microcontroller, microprocessor, or a combination thereof. These devices can include or be coupled to memory that stores instructions for carrying out the various functions described above. The central processing circuit can be positioned on a printed circuit board (e.g., motherboard) positioned in the controller sub-enclosure 104.

Various modifications and additions can be made to the embodiments disclosed without departing from the scope of this disclosure. For example, while the embodiments described above refer to particular features, the scope of this disclosure also includes embodiments having different combinations of features and embodiments that do not include all of the described features. Accordingly, the scope of the present disclosure is intended to include all such alternatives, modifications, and variations as falling within the scope of the claims, together with all equivalents thereof.

We claim:

1. A method comprising:
receiving, by a processor, a data retrieval command from a host requesting data;
in response to the data retrieval command, searching a mapping for the requested data, wherein the mapping includes a tree structure comprising a series of nodes and a linked list associated with each node;
identifying portions of the linked list associated with the requested data; and
communicating the requested data to the host.

2. The method of claim 1, wherein the linked list includes a series of linked-list nodes.

3. The method of claim 2, wherein the linked-list nodes include a data field and a link to the next linked-list node within the linked list.

4. The method of claim 1, wherein the series of nodes represents respective sets of data, wherein the linked list represents subsets of the sets of data.

5. The method of claim 1, wherein the series of nodes represents a virtual address, wherein the linked list represents physical addresses associated with the virtual address.

6. The method of claim 5, wherein the physical addresses are logical block addresses.

7. The method of claim 6, wherein each virtual address includes a string of characters, at least one of which indicates a particular data storage device.

8. The method of claim 7, wherein the string of characters indicates different storage offsets, which indicate different data storage capacities.

9. The method of claim 1, wherein the data retrieval command includes a requested key-value pair, wherein the series of nodes represents a key of the key-value pair, wherein the linked list represents subsets of data associated with the key-value pair.

10. The method of claim 1, wherein the tree structure is a balanced M-way search tree, balanced B tree, or balanced B+ tree.

11. An enclosure comprising:
sub-enclosures positioned at different levels along the enclosure;
data storage devices positioned within the sub-enclosures; and
a central processing integrated circuit programmed to store and retrieve data on the data storage devices according to a first mapping stored on memory communicatively coupled to the central processing integrated circuit, the first mapping including a first tree structure comprising a first series of nodes and a first linked list associated with each node.

12. The enclosure of claim 11, wherein the first linked list includes a series of linked-list nodes, which include a data field and a link to the next linked-list node within the first linked list.

13. The enclosure of claim 11, wherein the first series of nodes represents a set of data, wherein the first linked list represents subsets of the set of data.

14. The enclosure of claim 11, wherein the data storage devices include a first type of storage media and a second type of storage media, wherein the first mapping is associated with the first type of storage media, wherein a second mapping is associated with the second type of storage media.

15. The enclosure of claim 11, wherein the first series of nodes represents sets of data, wherein the first linked list represents subsets of the sets of data, wherein a second mapping includes a second tree structure comprising a second series of nodes and a second linked list, wherein the second series of nodes represents respective virtual addresses, wherein the second linked list represents physical addresses associated with the respective virtual addresses.

16. The enclosure of claim 15, wherein the virtual addresses each include a string of characters, at least one of which indicates a particular one of the data storage devices.

17. The enclosure of claim 11, wherein the first tree structure is a balanced M-way search tree, balanced B tree, or balanced B+ tree.

18. A system comprising:
an enclosure with sub-enclosures positioned at different levels along the enclosure;
data storage devices positioned within the sub-enclosures, the data storage devices including a group of hard disk drives and a group of magnetic tape drives; and
memory storing a first set of virtual addresses associated with data stored to the group of hard disk drives and a second set of virtual addresses associated with data stored to the group of magnetic tape drives.

19. The system of claim 18, wherein each virtual address includes a digit that represents a specific one of the data storage devices.

20. The system of claim 19, wherein each virtual address includes digits that represent data storage offsets.
